(19) United States
(12) Patent Application Publication
(10) Pub. No.: US 2012/0181060 A1
(43) Pub. Date: Jul. 19, 2012

(54) FLEXIBLE FLAT CABLE

(75) Inventors: Chiao Chen, New Taipei (TW); Xian-Bao Su, Kunshan (CN); Feng-Hua Liu, Kunshan (CN)

(73) Assignee: HON HAI PRECISION INDUSTRY CO., LTD., New Taipei (TW)

(21) Appl. No.: 13/349,573

(22) Filed: Jan. 13, 2012

(30) Foreign Application Priority Data
Jan. 14, 2011 (CN) 201120012067.9

(51) Int. Cl. H01B 7/08

(52) U.S. Cl. 174/117 F

(57) ABSTRACT

A flexible flat cable (1) comprises: a plurality of conductors (21) arranged along a transversal direction and paralleled with each other; an insulator (22) enclosing the plurality of conductors. The insulator defines a cutout formed on a top surface thereof to make a length of the plurality of conductors exposed out of the insulator for coupling with an electrical connector. And a first insulative layer (23), a second insulative layer (24) and a metallic layer (25) are stacked with each other and attached onto the top surface of the insulator and arranged from inside to outside in turn. And the first and second insulative layers are formed by different materials.

### FIELD OF THE INVENTION

The present invention relates to a flexible flat cable, and more particularly to a flexible flat cable with a characteristic impedance easily adjusted and achieved.

### DESCRIPTION OF PRIOR ART

The flexile flat cable, FFC, is one kind of signal transmitting wire with high flexibility and high signal transmitting ability. Because of these advantages, the flexile flat cable has been applied in many electric products. When being applied, the flexile flat cable is usually coupled with an electric connector for transmitting a signal from one terminal to another terminal The electric connector used in the low voltage differential signaling receiver, LVDS receiver, of the LCD displayer, has the characters such as high transmission speed, low power lost and low electromagnetic radiation, and such electric connector usually uses flexile flat cable as a transmission interface for transmitting signal stably. Now, the flexible flat cable is widely used in some electric devices, such as LCD monitor, notebook, printer and scanner, etc.

China Pat. No. 1278338 issued to P-TWO on Oct. 4, 2006 discloses a flexible flat cable. The flexible flat cable comprises a conductive wire layer, a lower insulative layer and an upper insulative layer attached to two sides of the conductive wire layer and a metallic shielding layer attached onto a top surface of the upper insulative layer. And, the metallic shielding layer 12 is arranged on the upper insulative layer in silver ink coating or metal meshed manner. The metallic shielding layer 12 has a lot of hollow out units. Thus, the flexible flat cable is able to match the standard of characteristic impedance of electric connector due to adjust a size of the hollow out unit of the metallic shielding layer. However, the above said method of adjusting the characteristic impedance of the flexible flat cable is complicated and difficult.

As discussed above, an improved flexible flat cable overcoming the shortages of existing technology is needed.

### SUMMARY OF THE INVENTION

Accordingly, an object of the present invention is to provide a new and simple structure of the flexible flat cable to achieve and adjust characteristic impedance thereof.

In order to achieve the above-mentioned objects, a flexible flat cable comprises: a plurality of conductors arranged along a transversal direction and paralleled with each other; an insulator enclosing the plurality of conductors, the insulator defining a cutout formed on a top surface thereof to make a length of the plurality of conductors exposed out of the insulator for coupling with an electrical connector; and a first insulative layer, a second insulative layer and a metallic layer stacked with each other and attached onto the top surface of the insulator and arranged from inside to outside in turn, and the first and second insulative layers formed by different materials.

Other objects, features and advantages of the invention will be apparent from the following detailed description taken in connection with the accompanying drawings.

### BRIEF DESCRIPTION OF THE DRAWINGS

FIG. 1 is a plan view of a flexible flat cable in accordance with the present invention.

FIG. 2 is an upward view of the flexible flat cable of FIG. 1.

FIG. 3 is cross section view take along line A-A of FIG. 1.

### DETAILED DESCRIPTION OF PREFERRED EMBODIMENTS

Reference will now be made to the drawing figures to describe the present invention in detail.

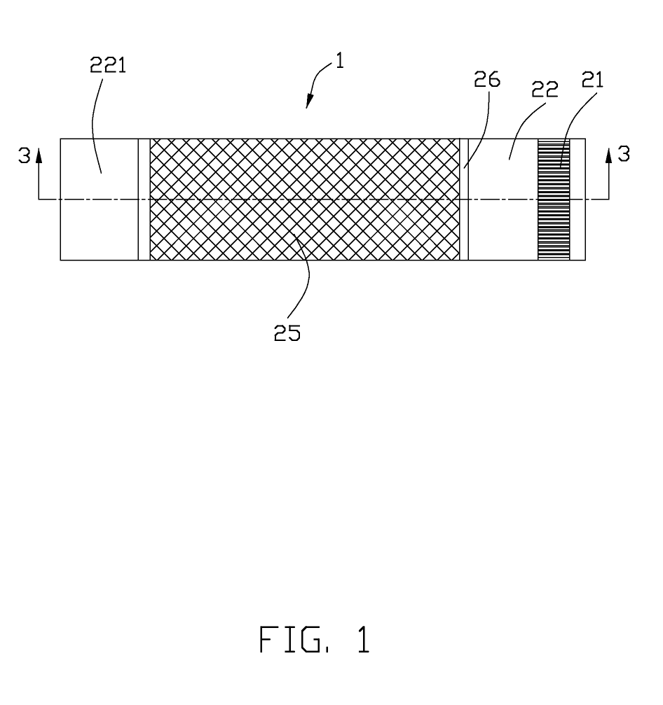

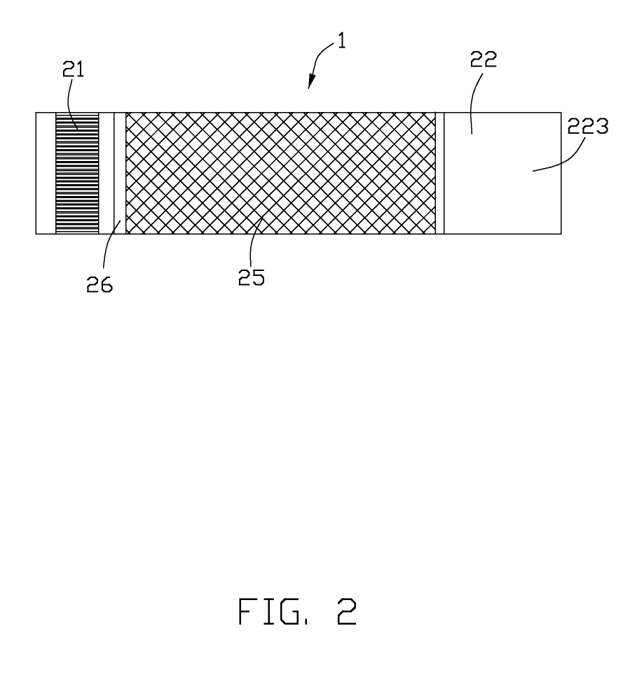

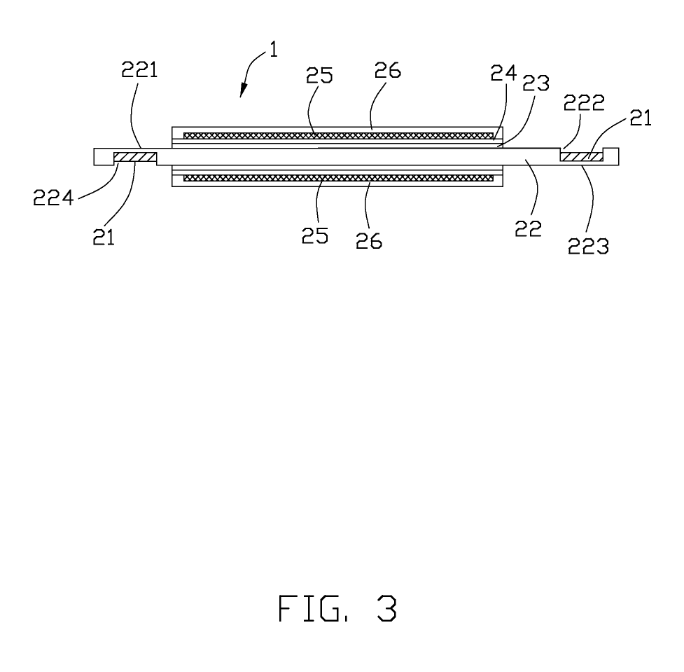

Referring to FIGS. 1 to 3, a flexible flat cable 1 comprises a plurality of conductors 21 and an insulator 22 enclosing the plurality of conductors 21. The plurality of conductors 21 are arranged along a transversal direction and paralleled with each other. The insulator 22 is made of polyethylene terephthalate (PET). The insulator 22 defines a top surface 221 and a bottom surface 223. The insulator 22 of the flexible flat cable 1 has a cutout 222 formed on the top surface 221 thereof and located on a right side of the flexible flat cable 1. Thus, a length of the plurality of conductors 21 are exposed out of the insulator 22. And a plurality of right free ends of the plurality of conductors 21 are remain enclosed by the insulator 22. Additionally, the insulator 22 of the flexible flat cable 1 has a cutout 224 formed on the bottom surface 223 thereof and located on a left side of the flexible flat cable 1. Thus, a length of the plurality of conductors 21 are exposed out of the insulator 22. And a plurality of left free ends of the plurality of conductors 21 are remain enclosed by the insulator 22. Actually, two cutouts 222, 224 are located adjacent two sides of the flexible flat cable 1.

Referring to FIGS. 1 to 3, the flexible flat cable 1 further comprises a first insulative layer 23, a second insulative layer 24 and a metallic layer 25 stacked with each other and attached onto the top surface 221 of the insulator 22 and arranged from inside to outside in turn. The flexible flat cable 1 also comprises a first insulative layer 23, a second insulative layer 24 and a metallic layer 25 stacked with each other and attached onto the bottom surface 223 of the insulator 22 and arranged from inside to outside in turn. It should be noted that the first insulative layer 23 and the second insulative layer 24 formed by different materials. In addition, the flexible flat cable 1 further comprises two protective layer 26 respectively covering two metallic layer 25 to protect the two metallic layer 25 from scraping . The protective layer 26 is formed of UV curable varnish. The metallic layer 25 is formed of silver plasma layer or aluminum foil. The first insulative layer 23 is made of polyethylene terephthalate (PET) or polyimide or other insulative material. The second insulative layer 24 is also made of polyethylene terephthalate (PET) or polyimide or other insulative material. And, the first and second insulative layers 23, 24 are formed by different materials.

The characteristic impedance of the flexible flat cable 1 is adjusted and controlled by the first and second insulative layer 23, 24 with different materials. Thus, the flexible flat cable 1 is easily manufactured and can be applied in different electric devices.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A flexible flat cable comprising:
a plurality of conductors arranged along a transversal direction and paralleled with each other;
an insulator enclosing the plurality of conductors, the insulator defining a cutout formed on a top surface thereof to make a length of the plurality of conductors exposed out of the insulator for coupling with an electrical connector; and
a first insulative layer, a second insulative layer and a metallic layer stacked with each other and attached onto the top surface of the insulator and arranged from inside to outside in turn, and the first and second insulative layers formed by different materials.

2. The flexible flat cable as recited in claim 1, wherein the insulator defines another cutout formed on a bottom surface thereof to make a length of the plurality of conductors exposed out of the insulator for coupling another electrical connector.

3. The flexible flat cable as recited in claim 2, wherein the flexible flat cable further comprises a first insulative layer, a second insulative layer and a metallic layer attached onto the bottom surface of the insulator and arranged from inside to outside in turn, and the first and second insulative layer formed by different materials.

4. The flexible flat cable as recited in claim 1, wherein the flexible flat cable further comprises a protective layer covering with the metallic layer.

5. The flexible flat cable as recited in claim 2, wherein the two cutouts of the insulator are located adjacent two free ends of flexible flat cable.

6. The flexible flat cable as recited in claim 1, wherein the metallic layer is formed of silver plasma layer or aluminum foil.

7. The flexible flat cable as recited in claim 4, wherein the protective layer is formed of UV curable varnish.

8. A flexible flat cable, comprising:
a plurality of conductors arranged along a transversal direction and paralleled with each other;
an insulator enclosing the plurality conductors and defining two cutouts to make two portions of the plurality of conductors exposed out of the insulator;
a pair of first insulative layers respectively attached onto a top and bottom surfaces of the insulator;
a pair of second insulative layers respectively attached onto two outer surfaces of the pair of first insulative layers; and
a pair of metallic layers respectively attached onto two outer surfaces of the second pair of second insulative layers, and the first and second insulative layers formed by different materials.

9. The flexible flat cable as recited in claim 8, wherein the flexible flat cable further comprises a pair of protective layers respectively covering with two metallic layers.

10. The flexible flat cable as recited in claim 9, wherein the two cutouts are respectively formed on the top and bottom surfaces of the insulator.

11. The flexible flat cable as recited in claim 9, wherein the metallic layer is formed of silver plasma layer or aluminum foil.

12. The flexible flat cable as recited in claim 9, wherein the protective layer is formed of UV curable varnish.

13. A flexible flat cable assembly comprising:
a plurality of strip like conductors arranged side by side in a first direction; and
an insulator enclosing said conductors to form a band like configuration with thereof opposite first and second ends in a second direction perpendicular to said first direction and opposite first and second faces in a third direction perpendicular to both said first direction and said second direction; wherein the first face defines a first opening around the first end while the second face defines a second opening around the second end to expose the corresponding conductors in different directions.

14. The flexible flat cable assembly as claimed in claim 13, wherein another flexible flat cable set is applied unto the first face between the opposite first and second ends, and said another flexible flat cable set includes at least a metallic layer covered by an outer insulative layer for not exposure to an exterior in the third direction.

15. The flexible cable assembly as claimed in claim 14, wherein said another flexible flat cable set further includes an inner insulative layer sandwiched between the metallic layer and the first face of the insulator.

16. The flexible cable assembly as claimed in claim 15, wherein said inner insulative layer includes an inner half layer intimately adjacent to the first face of the insulator, and an outer half layer intimately adjacent to the metallic layer, said inner half layer and the outer half being materially different from each other.

17. The flexible cable assembly as claimed in claim 13, wherein two additional flexible flat cable sets are respectively applied upon the opposite first and second faces and between the opposite first and second ends, each of said flexible flat cable sets includes at least a metallic layer covered by an outer insulative layer for not exposure to an exterior in the third direction.

18. The flexible cable assembly as claimed in claim 17, wherein each of said another flexible flat cable sets further includes an inner insulative layer sandwiched between the metallic layer and the insulator.

19. The flexible cable assembly as claimed in claim 18, wherein said inner insulative layer includes an inner half layer intimately adjacent to the insulator, and an outer half layer intimately adjacent to the metallic layer, said inner half layer and the outer half being materially different from each other.
